(19) United States
(12) Patent Application Publication
(10) Pub. No.: US 2025/0335954 A1
(43) Pub. Date: Oct. 30, 2025

(54) NOTIFICATION DEVICE, NOTIFICATION SYSTEM, NOTIFICATION METHOD, AND RECORDING MEDIUM

(71) Applicant: Rakuten Group, Inc., Tokyo (JP)

(72) Inventor: Keigo NAKAMURA, Tokyo (JP)

(73) Assignee: Rakuten Group, Inc., Tokyo (JP)

(21) Appl. No.: 19/176,373

(22) Filed: Apr. 11, 2025

(30) Foreign Application Priority Data
Apr. 30, 2024 (JP) 2024-074059

(51) Int. Cl. G06Q 30/0241

(52) U.S. Cl. CPC G06Q 30/0241

(57) ABSTRACT

A notification device includes a list request acquirer and a generator. The list request acquirer acquires, together with a list request for requesting a list of advertisements, an application identification (ID) that is information for identifying an application sending the list request. The generator generates, based on extraction setting information that is associated with the application ID acquired by the list request acquirer and is used for selection of the advertisements and determination of a display order, a list page including a plurality of objects representing summaries of the advertisements.

### CROSS-REFERENCE TO RELATED APPLICATIONS

This application claims the benefit of Japanese Patent Application No. 2024-074059, filed on Apr. 30, 2024, the entire disclosure of which is incorporated by reference herein.

### FIELD OF THE INVENTION

The present disclosure relates to a notification device, a notification system, a notification method, and a recording medium.

### BACKGROUND OF THE INVENTION

Systems are known that distribute advertisements through networks such as the Internet. For example, Japanese Patent Application Publication No. 2002-170027 discloses an advertisement distribution system that, when a request for a list of advertisements is input, outputs to a communication network the list of advertisements with communication identification information of a user inputting the request, and when selection information for selecting an advertisement is input, outputs the selected advertisement and stores in a user data file a benefit to be granted to the user based on an advertisement distribution history of the user.

This advertisement distribution system extracts distributable advertisements from advertisements contained in an advertisement data file to generate the list of advertisements.

### SUMMARY OF THE INVENTION

However, the above-described advertisement distribution system does not take into consideration the display order or types of advertisements displayed in the list of advertisements to be provided to a user. Therefore, in particular, when the list of advertisements is provided via an application, inappropriate advertisements may be provided to the user assumed to be a user of the application, and there has been thus room for improvement in terms of more effectively providing the list of advertisements.

The present disclosure is made with the view of the above-described situation, and an objective of the present disclosure is to provide a notification device, a notification system. a notification method, and a recording medium capable of more effectively providing a list of advertisements.

In order to solve the above-described problem, a notification device according to the present disclosure includes:
one or more processors, wherein
the processors
   acquire an application identification together with a list request for requesting a list of advertisements, the application identification being information for identifying an application sending the list request, and
   generate, based on extraction setting information associated with the acquired application identification and used for selection of the advertisements and determination of a display order, a list page including a plurality of objects representing summaries of the advertisements.

The present disclosure can provide a notification device, a notification system, a notification method, and a recording medium capable of more effectively providing a list of advertisements.

### BRIEF DESCRIPTION OF DRAWINGS

FIG. 1 illustrates an overall configuration of a notification system according to an embodiment;

FIG. 2 illustrates an example of an app screen displayed on a display screen of a terminal device;

FIG. 3 illustrates an example of a list page displayed on the display screen of the terminal device;

FIG. 4 illustrates an example of a detail page displayed on the display screen of the terminal device;

FIG. 5 is an explanatory diagram illustrating a functional configuration of a notification device;

FIG. 6 illustrates an example of an extraction setting table stored in an app database illustrated in FIG. 5;

FIG. 7 illustrates an example of an advertisement table stored in an advertisement database illustrated in FIG. 5;

FIG. 8 illustrates an example of an action history table stored in a user database illustrated in FIG. 5;

FIG. 9 is an explanatory diagram illustrating a hardware configuration of an information processing device; and

FIG. 10 is a flowchart of list provision processing performed by the notification device.

### DETAILED DESCRIPTION OF THE INVENTION

A notification device, a notification system, a notification method, and a program according to an embodiment of the present disclosure are described in detail with reference to the drawings. The same or equivalent parts in the drawings are designated by the same reference signs. Note that the present embodiment is intended for description and is not intended to limit the scope of the present disclosure. Accordingly, it is possible for persons skilled in the art to employ an embodiment in which part or all of the elements of the embodiment are replaced by equivalents thereof, which are also included in the scope of the present disclosure.

### Overall Configuration

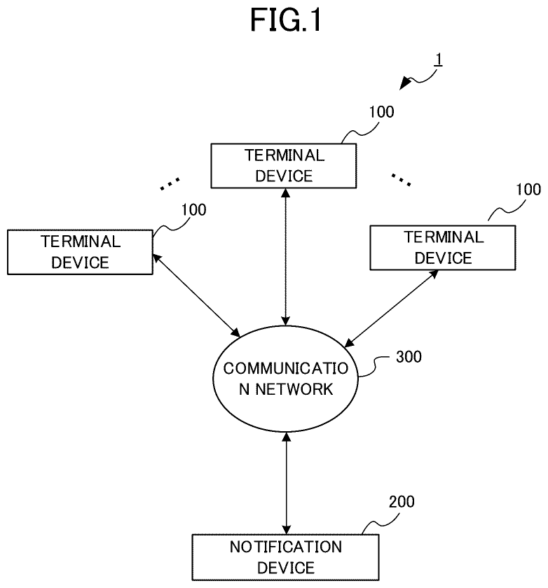

A notification device according to the embodiment of the present disclosure is described using an example in which the notification device is applied to a notification system 1 illustrated in FIG. 1. The notification system 1 is a system for generating, in accordance with a request from a terminal device 100, a list page on which objects representing summaries of advertisements are listed, and causing the terminal device 100 to display the generated list page on a display screen thereof.

Hereinafter, an example is described of a case in which a notification device 200 included in the notification system 1 is operated by an operator that provides a comprehensive Internet service, and causes the terminal device 100 to display a list page of advertisements including notification information for informing a user using the terminal device 100 of a campaign that grants a benefit to the user on the condition that the user takes a predetermined action.

The comprehensive Internet service is a service for providing a plurality of online services such as online shopping malls, flea market services, online supermarkets, reservation services for accommodation and other facilities, Internet banking, electronic payment services, healthcare services, online learning, sports fan clubs, point programs, point activity support services, and other services. The operator that provides the comprehensive Internet service operates a provision site for providing each of various services, and provides the user with application software (hereinafter, referred to as the “app”) for using each of the various services.

The notification system 1 includes one or more terminal devices 100 and a notification device 200. The terminal devices 100 are connected to the notification device 200 via a communication network 300 such as the Internet.

Each of the terminal devices 100 is an information terminal (a so-called computer) owned by the user, such as a smartphone, a tablet terminal, a personal computer, or the like. The terminal device 100 includes storage means for storing a plurality of apps for respective services provided by the operator that provides the comprehensive Internet service, communication means for performing transmission and reception of information with the notification device 200, and display means for displaying information. For example, for each service provided by the operator that provides the comprehensive Internet service, an app for use in the service is installed on the terminal device 100. The user starts the app to use each of the various services.

The communication means sends a list request for requesting the list page of advertisements to the notification device 200. Specifically, when the user performs an operation for requesting the list page on a screen of an app for any service in operation, the app sends, to the notification device 200, a request signal for requesting the list together with an app identification (ID) that is information for uniquely identifying the app. This list request is sent to the notification device 200 via the communication means.

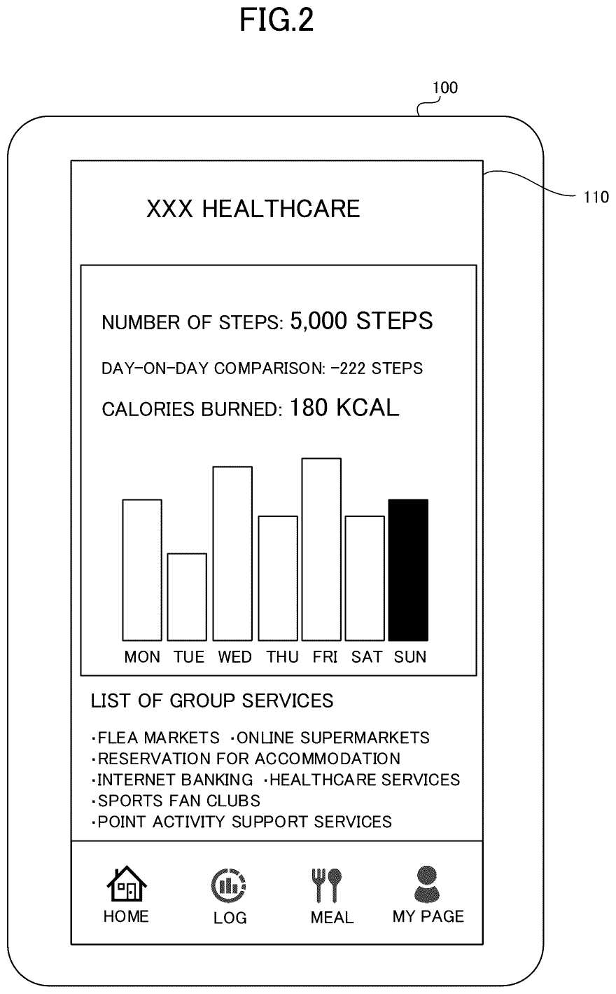

Here, an example of the operation for requesting the list page performed by the user is described with reference to FIG. 2. FIG. 2 illustrates an example of a display screen, displayed by the display means, of a healthcare app that provides a healthcare service. When a point activity support service that is a service for supporting point activities is selected by a user operation from a list of group services at the bottom of a display screen 110, the healthcare app sends, to the notification device 200 via the communication means, the list request for requesting the list page of advertisements together with the app ID of the healthcare app.

The display means displays the list page generated by the notification device 200 on the display screen 110. The terminal device 100 accepts a selection operation for selecting any of the objects displayed on the list page and representing summaries of advertisements. The display means displays, on the display screen 110, a detail page of an advertisement corresponding to the object selected by the user.

Returning back to FIG. 1, the notification device 200 includes one or a plurality of server computers. The notification device 200 selects advertisements in accordance with the attribute of the user assumed by the type of the app identified by the app ID sent from the terminal device 100, determines the display order of the advertisements to generate the list page of the advertisements, and causes the terminal device 100 to display the list page of the advertisements on the display screen 110 thereof.

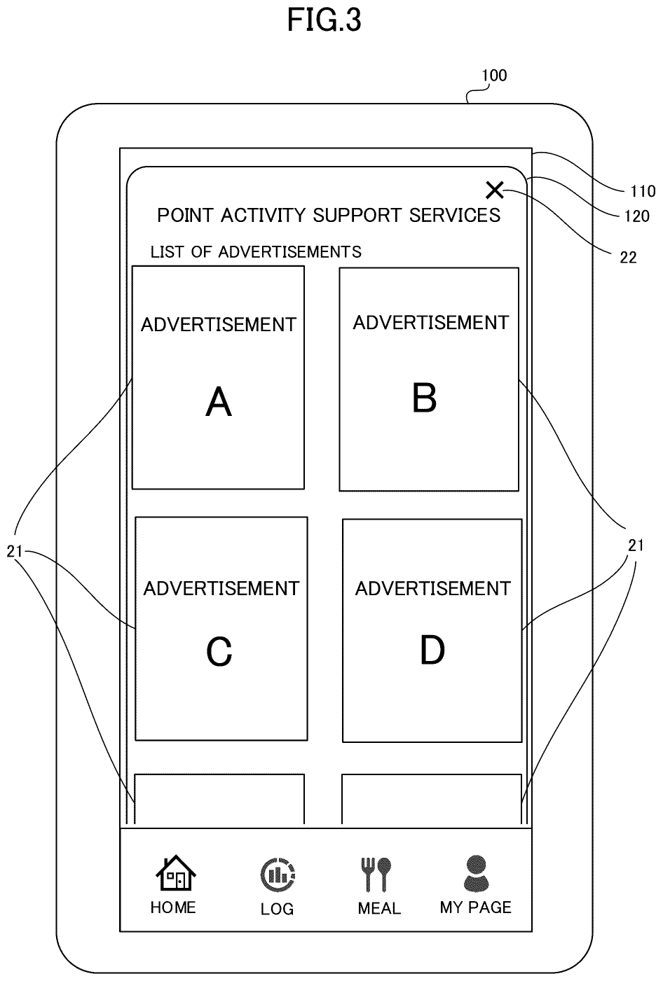

Here, an example of the list page generated by the notification device 200 is illustrated in FIG. 3. As illustrated, a plurality of objects 21 representing summaries of advertisements are arranged in a grid on a list page 120. The objects 21 include, for example, thumbnail images, advertising text, and the like representing products or services to be advertised. The terminal device 100 displays the list page 120 on a screen of the app in operation by processing through a web view for displaying web information in the app. Therefore, for example, when a close button 22 in the upper right portion of the list page 120 is selected, the screen of the healthcare app illustrated in FIG. 2, which has been displayed on the display screen 110 immediately before displaying the list page 120, is displayed. When all of the objects 21 cannot be displayed at once on the list page 120, the terminal device 100 may display all of the objects 21 on the list page 120 by scrolling the list page 120 vertically.

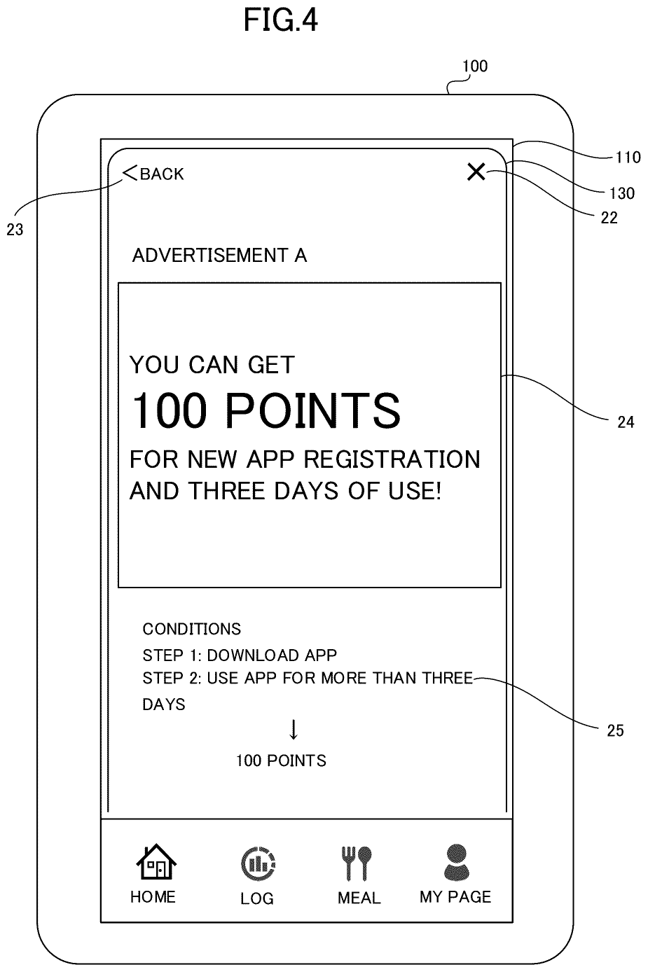

When any of the objects 21 displayed on the list page 120 is selected by the user through the selection operation, the notification device 200 causes the terminal device 100 to display the detail page of an advertisement corresponding to the selected object 21 on the display screen 110 thereof. Specifically, for example, when the object 21 of “Advertisement A” is selected on the list page 120 illustrated in FIG. 3, the notification device 200 sends an address of the detail page of “Advertisement A” to the terminal device 100, and causes the terminal device 100 to display the detail page on the display screen 110 thereof. Here, an example of the detail page is illustrated in FIG. 4. As illustrated, a detail page 130 includes an image 24 that represents details of a campaign and character information 25 that describes conditions under which a benefit is granted to the user. The user views the detail page 130 to confirm the conditions for obtaining the benefit. When the conditions are satisfied, the benefit is granted to the user.

As illustrated in FIG. 4, the close button 22 for closing the detail page 130 is disposed in the upper right portion of the detail page 130, and a back button 23 for returning back to a previous page is disposed in the upper left portion of the detail page 130. As with display processing of the list page 120, the terminal device 100 displays the detail page 130 of an advertisement on the screen of the app in operation by processing through the web view. Therefore, when the close button 22 is selected, the previous display screen 110 of the healthcare app illustrated in FIG. 2 is displayed, and when the back button 23 is selected, the list page 120 illustrated in FIG. 3 is displayed.

Returning back to FIG. 1, the communication network 300 can include various types of networks. Examples of the networks include a local area network (LAN), a wide area network (WAN) such as the internet, a telecommunications network such as a public switched telephone network (PSTN), a wireless network, a public switched network, a satellite network, a cellular network, a public land mobile network (PLMN), a metropolitan area network (MAN), a private network, an ad-hoc network, an intranet, an optical fiber-based network, or any combination of these or other types of networks.

### Functional Configuration of Notification Device

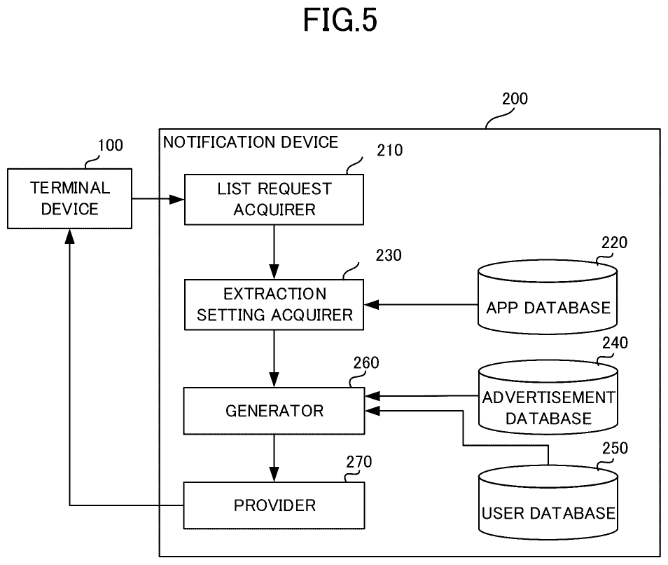

Next, using FIG. 5, a functional configuration of the notification device 200 is described. The notification device 200 includes a list request acquirer 210, an app database 220, an extraction setting acquirer 230, an advertisement database 240, a user database 250, a generator 260, and a provider 270.

The list request acquirer 210 acquires, from the terminal device 100, the list request for requesting a list of advertisements and an app ID that is information for uniquely identifying an app sending the list request. The list request acquirer 210 may acquire a user ID that is information for uniquely identifying a user using the terminal device 100, in addition to the list request and the app ID.

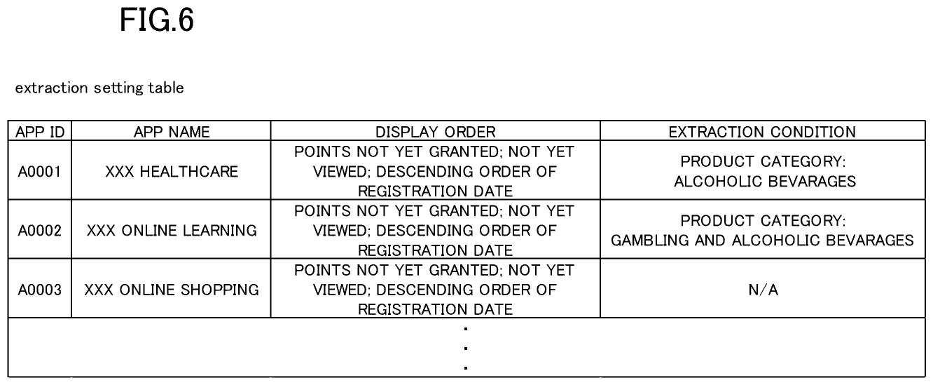

The app database 220 is a database for extracting advertisements to be displayed on the list page 120 for each app provided by the operator and storing an extraction setting table including rules for determining the display orders. An example of the extraction setting table is illustrated in FIG. 6.

As illustrated in FIG. 6, the extraction setting table is a table associating “App ID” that is information for uniquely identifying an app, “Display Order” that defines a rule for determining the display order of advertisements corresponding to the objects 21 to be displayed on the list page 120, and “Exclusion Condition” that defines conditions for advertisements to be excluded from the list page 120. The app ID is an example of an application identification.

In cells of “Display Order” in the extraction setting table, the rules for determining the display orders are entered. As illustrated in FIG. 6, when a plurality of conditions are entered in a cell of “Display Order”, each of the conditions is separated by a semicolon, and there is a rule that a higher priority is assigned to a condition on the left. Therefore, the display order illustrated in FIG. 6, “points not yet granted; not yet viewed; descending order of registration date” indicates that the display order of advertisements is determined by assigning the highest priority to advertisements for which points have not yet been granted to the user to which the list page 120 is to be presented, then assigning the next highest priority to advertisements to advertisements that have not yet been viewed by the user, and assigning a higher priority to an advertisement with a later registration date.

In cells of “Exclusion Condition” in the extraction setting table, the conditions for advertisements to be excluded from the list page 120 are entered. For example, categories and characteristics of products to be advertised may be entered, or keywords for the advertisements may be entered, in any format. In addition, a plurality of conditions may be entered in a cell of “Exclusion Condition”. In an example of “XXX Healthcare” illustrated in FIG. 6, the exclusion condition “Product Category: alcoholic beverages” indicates that advertisements related to alcoholic beverages are excluded from the list page 120 to be presented to the user. That is, since the user using the healthcare service is assumed to be health-conscious, the advertisements of alcoholic beverages that are considered contrary to the purpose of healthcare are not displayed on the list page 120. In addition to the examples illustrated in FIG. 6, sports fan club apps, for example, are assumed to be used by children and may be thus set to exclude alcoholic beverages in a similar manner to the healthcare app.

Returning back to FIG. 5, the extraction setting acquirer 230 acquires extraction setting information that includes the rule for determining the display order and the exclusion condition set for each app. Specifically, for example, when the app ID “A0001” is acquired by the list request acquirer 210, the extraction setting acquirer 230 refers to the extraction setting table illustrated in FIG. 6 to acquire the rule for determining the display order, “points not yet granted; not yet viewed; descending order of registration date” and the exclusion condition, “Product Category: alcoholic beverages”, and send the acquired information to the generator 260.

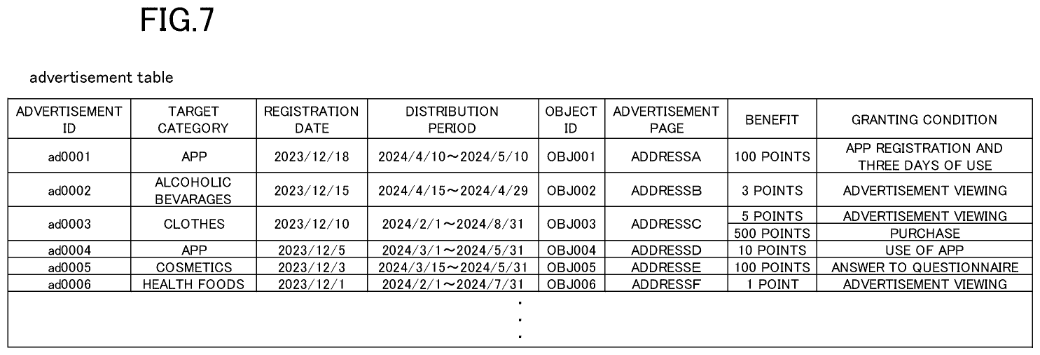

Returning back to FIG. 5, the advertisement database 240 is a database for storing an advertisement table that contains information of each advertisement to be displayed on the list page 120. Here, an example of the advertisement table is illustrated in FIG. 7. As illustrated, the advertisement table includes information such as “Advertisement ID” that is information for uniquely identifying an advertisement, “Target Category” that indicates a category of products or services to be advertised, “Registration Date” that indicates a registration date of advertisement distribution, “Distribution Period” that indicates a period of time during which the advertisement is to be distributed, “Object ID” for identifying object data of each object 21 displayed on the list page 120, “Advertisement Page” that indicates an address of the detail page of the advertisement, “Benefit” that indicates a benefit set to each advertisement, and “Granting Condition” that indicates user actions for which the benefit is to be granted. The advertisement table may further include any information, such as an advertiser ID that is information for uniquely identifying an advertiser or a keyword for an advertisement.

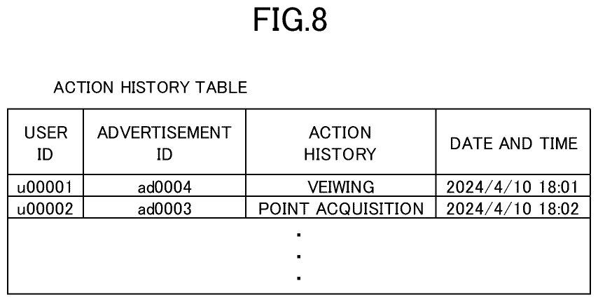

Returning back to FIG. 5, the user database 250 is a database for storing an action history table that contains an action history of the user using the terminal device 100 for each advertisement. Here, an example of the action history table is illustrated in FIG. 8. As illustrated, the action history table includes “User ID” that is information for uniquely identifying a user, “Advertisement ID” that is information for uniquely identifying an advertisement, “Action History” that indicates the action history of the user, and “Date and Time” that indicates date and time at which an action has been taken by the user. The action history table may further include any information, for example, a name of the user or attribute information of the user such as an address, occupation, family structure, or other information.

Returning back to FIG. 5, the generator 260 generates the list page 120 of advertisements to be provided to the terminal device 100. Specifically, the generator 260 selects advertisements to be displayed on the list page 120 from the advertisement database 240 and determines the display order based on the extraction setting information that includes the rule for determining the display order and the exclusion condition acquired by the extraction setting acquirer 230, and generates the list page 120 on which the objects 21 corresponding to the selected advertisements are arranged in the determined display order. Processing of the generator 260 is described later in detail.

The provider 270 sends an address of the list page 120 generated by the generator 260 to the terminal device 100, and causes the terminal device 100 to display the list page 120 on the display screen 110 thereof. The provider 270 also accepts selection input for selecting any of the objects 21 displayed on the list page 120, and sends, to the terminal device 100, an address of the detail page 130 corresponding to the selected object 21 to cause the terminal device 100 to display the detail page 130 on the display screen 110 thereof.

### Hardware Configuration of Information Processing Device

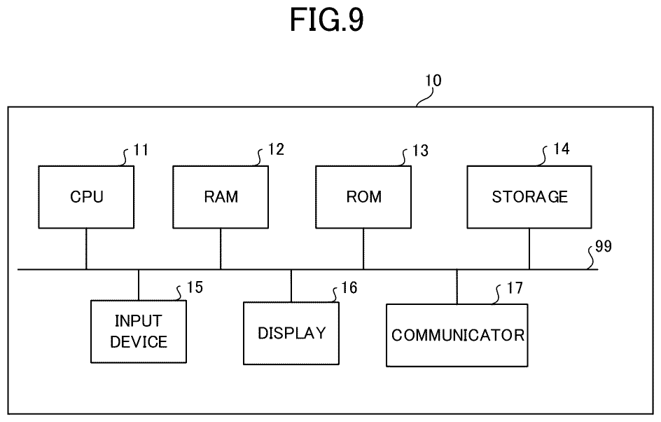

FIG. 9 is a block diagram illustrating a hardware configuration of an information processing device 10 that implements the terminal devices 100 and the notification device 200. The information processing device 10 includes a central processing unit (CPU) 11 that performs processing in accordance with a program, a random access memory (RAM) 12 that is a volatile memory, a read only memory (ROM) 13 that is a non-volatile memory, a storage 14 that stores data, an input device 15 that accepts input of information, a display 16 that visualizes and displays information, and a communicator 17 that performs transmission and reception of information, and these components are connected to one another via an internal bus 99.

The CPU 11 controls operations of the entire information processing device 10, is connected to the individual components, and sends or receives a control signal or data. The CPU 11 performs various types of processing by retrieving programs stored in the storage 14 to the RAM 12 and executing the programs. The CPU 11 performs, as main functions provided by the programs, the various types of processing for the list request acquirer 210, the extraction setting acquirer 230, the generator 260, and the provider 270 of the notification device 200.

The RAM 12 is provided to temporarily record data and/or programs, and retains the programs and/or data retrieved from the storage 14 and other data required for communication. The RAM 12 is used as a work area for the CPU 11.

The ROM 13 stores a control program, a basic input output system (BIOS), and the like that the CPU 11 executes for basic operations of the information processing device 10.

The storage 14 includes a hard disk drive, a flash memory, and the like, stores programs to be executed by the CPU 11, and stores various types of data for use in execution of the programs. The storage 14 functions as the storage means of the terminal device 100 and the app database 220, the advertisement database 240, and the user database 250 of the notification device 200.

The input device 15 is a user interface including a touch panel, a keyboard, a mouse, a communication device, and the like. The input device 15 accepts an operation input from a user of the information processing device 10 and outputs, to the CPU 11, a signal corresponding to the accepted operation input.

The display 16 is a display device for visualizing and displaying information, such as a liquid crystal display or an organic electro luminescence (EL) display. The display 16 functions as the display means of the terminal device 100.

The communicator 17 is a network terminal device or a radio communication device connected to a network, and a serial interface or a local area network (LAN) interface connected to the network terminal device or the radio communication device. The information processing device 10 can communicate with other information processing devices via the communicator 17. The communicator 17 functions as the communication means of the terminal device 100 and the list request acquirer 210 and the provider 270 of the notification device 200.

### List Provision Processing

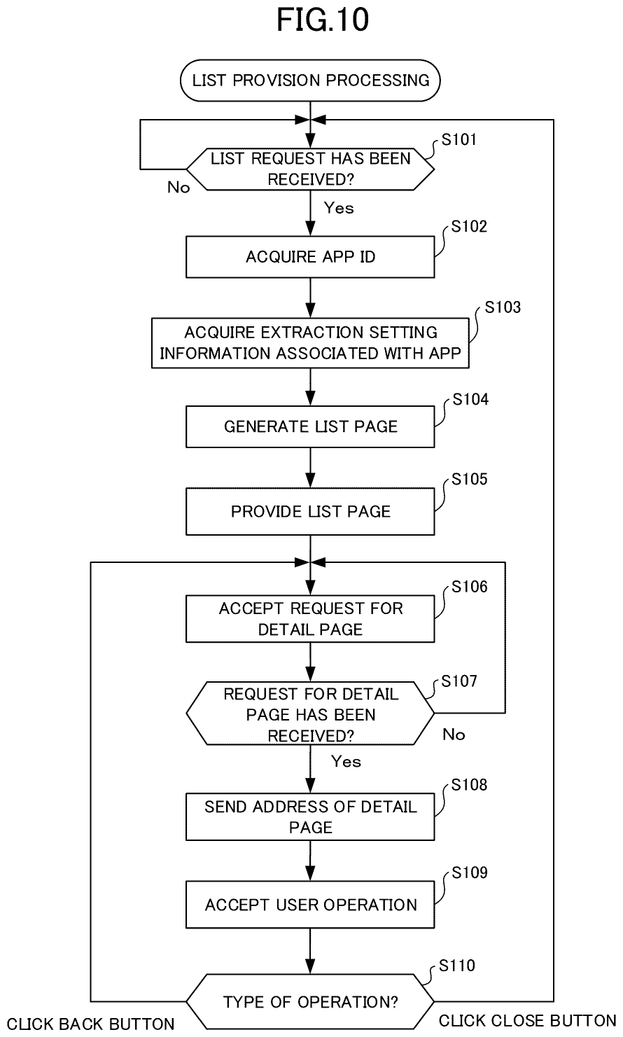

Next, operations of the notification device 200 are described with reference to FIG. 10. An example is described below of a case in which a user using a healthcare app for providing a healthcare service performs operations for requesting the list page 120 of advertisements. This app is provided by an operator that provides a plurality of services on the Internet, and the user can log in to the healthcare service through single sign on (SSO) using a user ID and a password that are pre-registered with this provider.

For example, when the user operates the terminal device 100 to start the healthcare app that is pre-installed on the terminal device 100 and input the user ID and the password to log in to the healthcare service, list provision processing starts. The user ID and the password may be automatically input without a user operation. When login is performed through the SSO, for example, a cookie is referred to verify whether there is a valid session, and when there is a valid session, the login can be performed without requesting the user ID and the password. In addition to the cookie, other data such as a token may be used to verify whether there is a valid session.

The list request acquirer 210 of the notification device 200 accepts, from the terminal device 100, the list request for requesting the list page 120 of advertisements, and determines whether the list request has been received (step S101). Specifically, on the display screen 110 of the healthcare app illustrated in FIG. 2, when the user selects a point activity support service from the list of group services at the bottom of the display screen 110, the healthcare app sends, to the notification device 200 via the communication means of the terminal device 100, the list request for requesting the list page 120 of advertisements together with the app ID of the healthcare app, “A0001”. For example, the app ID is incorporated into a source code of each app. The operation for requesting the list page 120 performed by the user is not limited the above-described case, and may be an operation selecting an icon or a banner for displaying the list page 120 of advertisements or may be any other operations.

When the list request has been received (Yes in step S101), the list request acquirer 210 sends the received list request to the extraction setting acquirer 230, and proceeds to step S102.

When the list request has not been received (No in step S101), the list request acquirer 210 accepts the list request until the list request is received.

Next, the extraction setting acquirer 230 acquires the app ID (step S102). Specifically, the extraction setting acquirer 230 acquires the app ID “A0001” that is included in the list request received in step S101.

The extraction setting acquirer 230 then acquires the extraction setting information that is associated with the app and includes the rule for determining the display order of advertisements and the exclusion condition for advertisements to be excluded from the list page (step $103). Specifically, the extraction setting acquirer 230 refers to the extraction setting table illustrated in FIG. 6 to identify, using the app ID “A0001” acquired in step S102 as a key, that the app used by the user is “XXX healthcare app”, and acquires the extraction setting information indicating that the rule for determining the display order in the healthcare app is “points not yet granted; not yet viewed; descending order of registration date” and the exclusion condition is “Product Category: alcoholic beverages”. The extraction setting acquirer 230 sends the acquired extraction setting information to the generator 260.

Returning back to FIG. 10, the generator 260 then generates the list page 120 of advertisements (step S104). Specifically, the generator 260 firstly refers to the advertisement table illustrated in FIG. 7 to extract advertisements of which the distribution period includes the current date, and excludes, from the extracted advertisements, advertisements that satisfy the exclusion condition acquired in step S103. For example, when the current date is Apr. 18, 2024, the generator 260 extracts advertisements with the advertisement IDs “ad0001”, “ad0002”, “ad0003”, “ad0004”, “ad0005”, and “ad0006”. The generator 260 then excludes, from the extracted advertisements, advertisements that satisfy the exclusion condition “Product Category: alcoholic beverages”. In the example illustrated in FIG. 7, the target category of the advertisement with the advertisement ID “ad0002” is “alcoholic beverages”, and the generator 260 thus excludes the advertisement with the advertisement ID “ad0002” from the advertisements to be displayed.

The generator 260 then determines, based on the rule for determining the display order acquired in step S103, the display order of the advertisements to be displayed. Specifically, the rule for determining the display order is “points not yet granted; not yet viewed; descending order of registration date”, and the generator 260 thus refers to the action history table illustrated in FIG. 8 and extracts the user action history of a user with the user ID “u00001” acquired at login to determine the display order. In the example illustrated in FIG. 7, the user with the user ID “u00001” has viewed the advertisement with the advertisement ID “ad0004”. Therefore, the generator 260 determines to assign higher priorities to the advertisements with the advertisement IDs “ad0001”, “ad0002”, “ad0003”, “ad0005”, and “ad0006” than the advertisement with the advertisement ID “ad0004”. The generator 260 is an example of an action history acquirer.

The generator 260 then assigns higher priorities to the advertisements with the advertisement IDs “ad0001”, “ad0002”, “ad0003”, “ad0005”, and “ad0006” in descending order of registration date, and generates the list page 120 on which the objects 21 corresponding to the advertisement IDs “ad0001”, “ad0002”, “ad0003”, “ad0005”, “ad0006”, “ad0004” are arranged in this order.

Next, the provider 270 sends, to the terminal device 100, the address of the list page 120 generated in step S104 to provide the terminal device 100 with the list page 120 (step S105), and causes the terminal device 100 to display the list page 120 illustrated in FIG. 3 on the display screen 110 thereof. The objects 21 are arranged in two columns in the example illustrated in FIG. 3, but may be arranged in one column or in any number of columns such as three or four columns.

The provider 270 then accepts, from the terminal device 100, a request for the detail page 130 of any of the advertisements corresponding to the objects 21 displayed on the list page 120 (step S106). Specifically, when the user selects any of the objects 21 displayed on the list page 120, the terminal device 100 sends, to the notification device 200, a signal for requesting the detail page 130 of an advertisement corresponding to the selected object 21 together with the object ID of the selected object 21.

When receiving the request for the detail page 130 (Yes in step S107), the provider 270 then refers to the advertisement table illustrated in FIG. 7, uses the received object ID as a key to acquire the address of the detail page 130 of the advertisement corresponding to the selected object 21, and proceeds to step S108. For example, when receiving, from the terminal device 100, the object ID “OBJ001” together with the request for the detail page 130, the provider 270 acquires the address “address A” of the detail page 130 of the advertisement with the advertisement ID “ad001”.

When determining that the request for the detail page 130 has not been received (No in step S107), the provider 270 returns back to step S106 and accepts the request for the detail page 130.

In step S108, the provider 270 sends, to the terminal device 100, the address of the detail page 130 acquired in step S107 (step S108) to provide the terminal device 100 with the detail page 130. When receiving the address of the detail page 130 from the provider 270, the terminal device 100 displays, by processing through the web view of the healthcare app that has instructed transmission of the list request, the detail page 130 with the received address on the display screen 110 as illustrated in FIG. 4.

The provider 270 then accepts a user operation on the detail page 130 displayed on the display screen 110 (step S109). When the user selects the back button 23 in the upper left portion of the detail page 130 illustrated in FIG. 4, the list page 120 illustrated in FIG. 3 is displayed by processing through the web view of the healthcare app. The terminal device 100 notifies the notification device 200 that the back button 23 has been selected. When receiving the notification notifying that the back button 23 has been selected, the notification device 200 returns back to step S106 and accepts the request for the detail page 130.

When the user selects the close button 22 in the upper right portion of the detail page 130 in step S109, the detail page 130 is closed by processing through the web view of the healthcare app, and the screen of the healthcare app illustrated in FIG. 2, which has been displayed on the display screen 110 immediately before transmission of the list request, is displayed. The terminal device 100 notifies the notification device 200 that the close button 22 has been selected. When receiving the notification notifying that the close button 22 has been selected, the notification device 200 returns back to step S101 and accepts the list request.

As described above, the notification device 200 generates the list page 120 of advertisements based on the extraction setting information that is associated with the app having sent the list request for requesting the list of advertisements and includes the rule for determining the display order of advertisements and the exclusion condition for extraction from the list. This enables adjustment or selection of the order and/or type of advertisements to be displayed on the list page 120 in accordance with the attribute of a user assumed by the type of an app in use, such as generation of the list page 120 that does not display or displays at the end advertisements of products contrary to the purpose of healthcare for a user using a healthcare app.

A configuration in which rules and conditions are set, based on the action history of a user for each advertisement, to the extraction setting information that is associated with an app allows the notification device 200 to, for example, exclude a campaign advertisement from the list page 120 or move the campaign advertisement to the end of the list page 120 for the user who have viewed the campaign advertisement or acquired a benefit. This enables more effectively providing the list page 120 of advertisements in accordance with the action history of the user.

### MODIFIED EXAMPLES

In the above-described embodiment, the rule by which the notification device 200 determines the display order of the objects 21 corresponding to advertisements on the list page 120 is not limited to the rule based on the action history of a user, and may be, for example, a rule that assigns a higher priority to an advertisement of a product or service closer to the attribute of an app. In this case, a configuration may be provided in which the extraction setting information illustrated in FIG. 6, which is stored in the app database 220, further contains attribute information that indicates the attribute of the app, and includes, as the rule for determining the display order, a rule that assigns a higher priority to the product or service closer to the attribute of the app. For example, in the app of “XXX Healthcare”, “health” may be set to the attribute of the app, and “products including the attribute of the app” may be set to “Display Order” that indicates a rule for determining the display order. This allows the notification device 200 to display, for a user using the healthcare app, at the top of the list page 120, the object 21 corresponding to the advertisement with the advertisement ID “ad0006” of which the category of products to be advertised is “health foods” in the advertisement table illustrated in FIG. 7.

The rule by which the notification device 200 determines the display order of the objects 21 corresponding to advertisements on the list page 120 may be a rule based on the amount of benefit to be granted to each user that is entered in the advertisement table illustrated in FIG. 7, for example, a rule that assigns a higher priority to an advertisement by which more points are granted.

In the above-described embodiment, the advertisements displayed on the list page 120 generated by the notification device 200 are advertisements for informing a user of a campaign that grants a benefit to the user on the condition that the user takes a predetermined action. However, the advertisements displayed on the list page 120 are not limited thereto, and may be advertisements that do not include a campaign.

In the above-described embodiment, the advertisements displayed on the list page 120 generated by the notification device 200 are advertisements by which points are granted as a benefit. However, the advertisements displayed on the list page 120 are not limited thereto, and the benefit may be any benefit, such as prizes, coupons, provision of content such as videos, images, songs, or the like, or an increase in the percentage of points granted.

The number of points granted on the condition that a user takes a predetermined action may be different for each user. Specifically, in the advertisement table illustrated in FIG. 7, a condition may be set on which a different number of points is granted based on the attribute of a user and the usage status of the user in each service.

The notification device 200 according to the above-described embodiment can be implemented by using a general computer instead of a dedicated device. For example, the notification device 200 that performs the above-described processing may be configured by installing the program in the computer from a non-transitory recording medium storing a program for causing the computer to perform one of the above-described types of processing. In addition, the notification device 200 may be configured by a plurality of computers operating in cooperation.

In addition, when the above-described functions are achieved by being divided between an operating system (OS) and an application, or are achieved by cooperation between the OS and the application, only programs other than the OS may be stored in the medium.

In addition, it is possible to superimpose programs on a carrier wave and distribute the programs via a communication network. For example, the programs may be distributed at an app store, or may be posted on a bulletin board system (BBS) on the communication network to be distributed via the network. Moreover, a configuration may be provided in which the above-described processing can be performed by starting the distributed programs and executing the programs in a similar manner to other application programs under the control of the OS.

In addition, a configuration may be provided in which information stored in the notification device 200 is collectively managed by a cloud server on the network and the notification device 200 accesses the cloud server to perform reading and writing of the information as needed. In this case, the notification device 200 does not have to include the app database 220, the advertisement database 240, and the user database 250. Moreover, the list provision processing performed by the notification device 200 may be performed on the cloud based on the information stored in the cloud server.

Hereinafter, various modes of embodiment of the present disclosure are collectively described as appendices. Appendix 1

A notification device comprising:
one or more processors, wherein
the processors
   acquire an application identification together with a list request for requesting a list of advertisements, the application identification being information for identifying an application sending the list request, and
   generate, based on extraction setting information associated with the acquired application identification and used for selection of the advertisements and determination of a display order, a list page including a plurality of objects representing summaries of the advertisements.

### Appendix 2

The notification device according to appendix 1, wherein
the advertisements include notification information for informing a campaign granting a benefit to a user on a condition that the user takes a predetermined action.

### Appendix 3

The notification device according to appendix 2, wherein
the processors
   further acquire a user identification being information for identifying a user using the application, and
   determine the display order of the plurality of objects included in the list page in accordance with an amount of the benefit to be granted to the user identified by the acquired user identification.

### Appendix 4

The notification device according to any one of appendices 1 to 3, wherein
the processors
   further acquire a user identification being information for identifying a user using the application, and
   acquire an action history of the user identified by the acquired user identification for each of the advertisements,
the extraction setting information includes a rule for determining the display order based on the action history of the user, and
the processors determine, based on the action history of the user identified by the acquired user identification, the display order of the plurality of objects included in the list page.

### Appendix 5

The notification device according to any one of appendices 1 to 4, wherein
the extraction setting information includes a condition for an advertisement of the advertisements to be excluded from the list page, and
the processors exclude the advertisement satisfying the condition from the advertisements to be displayed, determine the display order of advertisements not excluded from the advertisements to be displayed, and arrange the plurality of objects.

### Appendix 6

A notification system comprising:
the notification device according to any one of Appendices 1 to 5; and
a terminal device to send the application identification of an application used by a user together with the list request and display the list page generated by the notification device in response to the list request.

### Appendix 7

A notification method comprising:
acquiring, by a computer, an application identification together with a list request for requesting a list of advertisements, the application identification being information for identifying an application sending the list request; and
generating, by the computer, based on extraction setting information associated with the acquired application identification and used for selection of the advertisements and determination of a display order, a list page including a plurality of objects representing summaries of the advertisements.

### Appendix 8

A non-transitory computer-readable recording medium storing a program for causing a computer to perform processing comprising:
acquiring an application identification together with a list request for requesting a list of advertisements, the application identification being information for identifying an application sending the list request; and
generating, based on extraction setting information associated with the acquired application identification and used for selection of the advertisements and determination of a display order, a list page including a plurality of objects representing summaries of the advertisements.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

The present disclosure can provide a notification device, a notification system. a notification method, and a recording medium capable of more effectively providing a list of advertisements.

1. A notification device comprising:
one or more processors, wherein
the processors
acquire an application identification together with a list request for requesting a list of advertisements, the application identification being information for identifying an application sending the list request, and
generate, based on extraction setting information associated with the acquired application identification and used for selection of the advertisements and determination of a display order, a list page including a plurality of objects representing summaries of the advertisements.

2. The notification device according to claim 1, wherein
the advertisements include notification information for informing a campaign granting a benefit to a user on a condition that the user takes a predetermined action.

3. The notification device according to claim 2, wherein
the processors
further acquire a user identification being information for identifying a user using the application, and
determine the display order of the plurality of objects included in the list page in accordance with an amount of the benefit to be granted to the user identified by the acquired user identification.

4. The notification device according to claim 1, wherein
the processors
further acquire a user identification being information for identifying a user using the application, and
acquire an action history of the user identified by the acquired user identification for each of the advertisements,
the extraction setting information includes a rule for determining the display order based on the action history of the user, and
the processors determine, based on the action history of the user identified by the acquired user identification, the display order of the plurality of objects included in the list page.

5. The notification device according to claim 1, wherein
the extraction setting information includes a condition for an advertisement of the advertisements to be excluded from the list page, and
the processors exclude the advertisement satisfying the condition from the advertisements to be displayed, determine the display order of advertisements not excluded from the advertisements to be displayed, and arrange the plurality of objects.

6. A notification system comprising:
the notification device according to claim 1; and
a terminal device to send the application identification of an application used by a user together with the list request and display the list page generated by the notification device in response to the list request.

7. A notification method comprising:
acquiring, by a computer, an application identification together with a list request for requesting a list of advertisements, the application identification being information for identifying an application sending the list request; and
generating, by the computer, based on extraction setting information associated with the acquired application identification and used for selection of the advertisements and determination of a display order, a list page including a plurality of objects representing summaries of the advertisements.

8. A non-transitory computer-readable recording medium storing a program for causing a computer to perform processing comprising:
acquiring an application identification together with a list request for requesting a list of advertisements, the application identification being information for identifying an application sending the list request; and
generating, based on extraction setting information associated with the acquired application identification and used for selection of the advertisements and determination of a display order, a list page including a plurality of objects representing summaries of the advertisements.
